(19) United States
(12) Patent Application Publication
(10) Pub. No.: US 2005/0286375 A1
(43) Pub. Date: Dec. 29, 2005

(54) System and program for evaluating optical disk apparatus

(75) Inventor: Hiroshi Okamoto, Ueda-shi (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha

(21) Appl. No.: 11/155,482

(22) Filed: Jun. 20, 2005

(30) Foreign Application Priority Data
Jun. 28, 2004 (JP) 2004-189631

(51) Int. Cl. G11B 5/09

(52) U.S. Cl. 369/53.1; 369/59.1; 369/47.1

(57) ABSTRACT

The system is capable of easily evaluating quality of recorded data by detecting intersymbol interference of written data. The optical disk apparatus comprises: a unit for measuring pulse widths of high level sections and low level sections in a plurality of parts of a binarized RF signal in chronological order; memory unit for collecting pulse width data of a plurality of groups measured, in which the pulse width data of each group are the pulse width of one high level section and the pulse width of one low level section adjoining the high level section. The computer comprises: a part of UPU for processing the collected pulse width data, which are sent from the optical disk apparatus, so as to analyze intersymbol interference of the binarized RF signal; and another part of CPU for creating display data on the basis of the processed data.

### BACKGROUND OF THE INVENTION

The present invention relates to a system and a program for evaluating an optical disk apparatus, more precisely relates to a system and a program capable of evaluating quality of data recorded in an optical disk.

Some users are interested in not only writing data in an optical disk, e.g., CD, DVD, but also quality of data recorded or written in the optical disk.

Conventionally, quality of data recorded in an optical disk of an optical disk apparatus is evaluated by, for example, checking error rata or checking asymmetry value β of a reflected laser beam received by an optical pick-up (see Japanese Patent Gazettes No. 2003-59047 and No. 2003-162818).

Further, quality of recorded data can be evaluated by measuring pulse widths (time lengths) of high (H) level sections and low (L) level sections of a binarized RF signal (see FIG. 9).

The H-level sections and the L-level sections are alternately included in the binarized RF signal. The H-level sections indicate high light intensity of laser beams, which are reflected from lands formed in an recording surface of the optical disk and which are received by an optical pick-up; the L-level sections indicate low light intensity of laser beams, which are reflected from pits formed in the recording surface of the optical pick-up and which are received by the optical pick-up.

The pulse widths of the H-level sections and the L-level sections of the binarized RF signal depend on lengths of the lands and the pits formed in the recording surface of the optical disk (see FIG. 10).

In the optical disk, the lengths of the lands and pits are predetermined. The lands and pits are formed in a CD by irradiating EFM (Eight to Fourteen Modulation)-modulated laser beams from an optical pick-up or formed in a DVD by irradiating EFM⁺-modulated laser beams from the optical pick-up. By forming the lands and pits, data can be written or recorded in the optical disk.

By EFM-modulating or EFM⁺-modulating signals, the lengths of the lands and pits are determined on the basis of clock frequency.

In the following description, a standard length of the land and pit is defined as “T”. Actually, the lengths of the lands and pits formed in, for example, a DVD are 3T, 4T, . . . , 14T (except 12T and 13T). Namely, the length of the lands and pits are multiples of T.

Thus, quality of the recorded data can be evaluated by measuring pulse widths of the H-level sections and the L-level sections of the binarized RF signal and calculating deviations of the measured pulse widths from the predetermined lengths 3T, . . . , 14T.

Various methods of evaluating quality of recorded data by measuring deviations of pulse widths of the high- and low-level sections from the standard widths, e.g., 3T, 4T, are known. Especially, a method, in which intersymbol interference is measured, is capable of precisely evaluating the quality of recorded data.

The intersymbol interference will be explained.

As described above, in an optical disk apparatus, data are modulated when the data are written. In one sector of an optical disk, when a H-level section having a pulse width of 4T and a L-level section having a pulse width of 3T are serially generated as shown in FIG. 11, modulation is performed to make a total pulse width of the 4T H-level section and the 3T L-level section a fixed width even if lengths of the 4T H-level section and the 3T L-level section are slightly varied. Namely, if the 4T H-level section is slightly longer, the pulse width of the 3T L-level section is slightly shortened, and vice versa.

The intersymbol interference can be detected by the steps of: measuring pulse widths of a H-level section and a L-level section of a binarized RF signal, which serially appear; and measuring deviations of the measured pulse widths with respect to the standard pulse widths, e.g., 3T, 4T. For example, if 3T L-level sections, each of which follows a 4T H-level section, tend to be made longer, the intersymbol interference between 3T L-level sections and 4T L-level sections can be detected. Therefore, quality of recorded data can be precisely evaluated.

Note that, conventional optical disk apparatuses have no means for evaluating quality of data recorded in an optical disk.

To evaluate quality of recorded data by detecting the intersymbol interference, a user must prepare a dedicated apparatus for evaluating quality of recorded data. However, the dedicated apparatuses are expensive, so they have been used by manufacturers of optical disk apparatuses. Namely, ordinary users cannot evaluate quality of recorded data.

A software for detecting the intersymbol interference, which can be installed in ordinary computers, exists, but it is usually used with the expensive dedicated apparatus. Therefore, ordinary users cannot use the software.

### SUMMARY OF THE INVENTION

An object of the present invention is to provide a system for evaluating an optical disk apparatus, which is capable of easily evaluating quality of recorded data by detecting intersymbol interference of written data.

Another object of the present invention is to provide a program for evaluating an optical disk apparatus.

To achieve the objects, the present invention has following structures.

Namely, the system for evaluating optical disk apparatus includes an optical disk apparatus, which is capable of writing data in an optical disk, and a computer, which is connected to the optical disk apparatus and capable of communicating therewith, wherein the optical disk apparatus comprises: an optical pick-up irradiating an laser beam toward the optical disk and receiving a reflected laser beam reflected from the optical disk; means for generating a binarized RF signal, which alternately includes high level sections corresponding to lands formed in a recording surface of the optical disk and low level sections corresponding to pits formed in the recording surface of the optical disk, from the reflected laser beam received by the optical pick-up; means for measuring pulse widths of the high level sections and the low level sections in a plurality of parts of the binarized RF signal in chronological order; means for collecting pulse width data of a plurality of groups measured by the measuring means, in which the pulse width data of each group are the pulse width of one high level section and the pulse width of one low level section adjoining the high level section; and an interface capable of forwarding the collected pulse width data to the computer, and wherein the computer comprises: display means; an interface capable of communicating with the optical disk apparatus; means for processing the collected pulse width data, which are sent from the optical disk apparatus, so as to analyze intersymbol interference of the binarized RF signal; and means for creating display data, which are shown by the display means, on the basis of the data processed by the processing means.

With this structure, a user can analyze intersymbol interference, with watching the display means, so as to evaluate quality of the recorded data. Therefore, the quality of the recorded data can be easily and precisely evaluated.

In the system, the processing means may process the collected pulse width data so as to show a graph on the display means, a horizontal axis of the graph may be the pulse width of one of the high-level section and the low-level section, and a vertical axis of the graph may be the pulse width of the other, the graph may indicate relationship between the pulse width of the high-level section and the pulse width of the low-level section of the groups, and the creating means may create the display data for showing the graph.

With this structure, when lengths of the land and the pit, which adjoins the land, are deviated from standard lengths, intersymbol interference, in which the deviated land or pit interferes with other lands or pits whose lengths are different from that of the deviated land or pit, can be known by watching the display means. Therefore, the user can easily and joyfully evaluates quality of the recorded data.

Further, the program for evaluating an optical disk apparatus, which is capable of writing data in an optical disk and connected to a computer, can be installed in the computer, the optical disk apparatus comprises: an optical pick-up irradiating an laser beam toward the optical disk and receiving a reflected laser beam reflected from the optical disk; means for generating a binarized RF signal, which alternately includes high level sections corresponding to lands formed in a recording surface of the optical disk and low level sections corresponding to pits formed in the recording surface of the optical disk, from the reflected laser beam received by the optical pick-up; means for measuring pulse widths of the high level sections and the low level sections in a plurality of parts of the binarized RF signal in chronological order; means for collecting pulse width data of a plurality of groups measured by the measuring means, in which the pulse width data of each group are the pulse width of one high level section and the pulse width of one low level section adjoining the high level section; and an interface capable of forwarding the collected pulse width data to the computer, and wherein the program has functions of: processing the collected pulse width data, which are sent from the optical disk apparatus, so as to analyze intersymbol interference of the binarized RF signal; and creating display data, which are shown by display means of the computer, on the basis of the processed data.

By using the program, the user can the data for analyzing the intersymbol interference by the display means of the computer, so that the quality of the recorded data can be easily and securely evaluated. Note that, the computer may be an ordinary computer, so the quality of the recorded data can be evaluated without using an expensive computer.

In the program, the collected pulse width data may be processed so as to show a graph on the display means, a horizontal axis of the graph may be the pulse width of one of the high-level section and the low-level section, and a vertical axis of the graph may be the pulse width of the other, the graph may indicate relationship between the pulse width of the high-level section and the pulse width of the low-level section of the groups, and the display data may be created to show the graph.

With this structure, when lengths of the land and the pit, which adjoins the land, are deviated from standard lengths, intersymbol interference, in which the deviated land or pit interferes with other lands or pits whose lengths are different from that of the deviated land or pit, can be known by watching the display means. Therefore, the user can easily and joyfully evaluates quality of the recorded data.

### BRIEF DESCRIPTION OF THE DRAWINGS

Embodiments of the present invention will now be described by way of examples and with reference to the accompanying drawings, in which:

FIG. 1 is a block diagram of an optical disk apparatus;

FIG. 2 is an explanation view showing a method of collecting data of pulse widths;

FIG. 3 is a block diagram of a computer;

FIG. 4 is a block diagram of the computer;

FIG. 5 is a flowchart showing action of the system;

FIG. 6 is a graph shown by a display;

FIG. 7 is another graph shown by the display;

FIG. 8 is an explanation view explaining inclination of a set of ellipses;

FIG. 9 is an explanation view of a binarized RF signal;

FIG. 10 is an explanation view of lands and pits formed on a recording face of an optical disk; and

FIG. 11 is an explanation view explaining a total length of a group of a land and a pit.

### DETAILED DESCRIPTION OF THE EMBODIMENTS

Preferred embodiments of the present invention will now be described in detail with reference to the accompanying drawings.

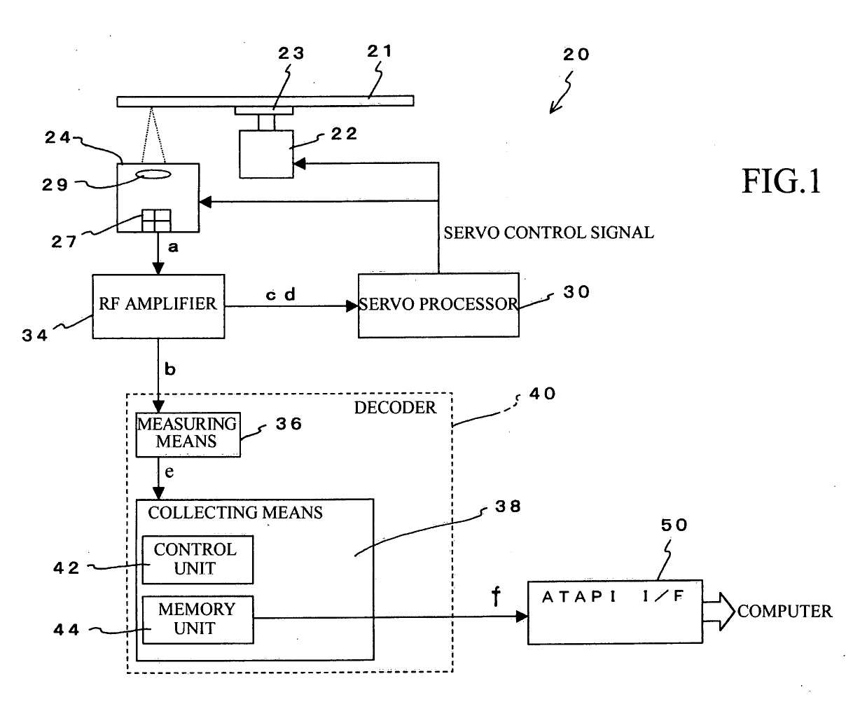

Firstly, a constitution of an optical disk apparatus of an embodiment will be explained with reference to FIG. 1.

An optical disk apparatus 20 comprises: a turn table 23, on which an optical disk 21 is set; a spindle motor 22 for rotating the turn table 23; and an optical pick-up 24 for irradiating a laser beam toward the optical disk 21 and receiving the laser beam reflected from the optical disk 21.

The optical pick-up 24 includes a laser diode (not shown) for irradiating the laser beam and a photo diode 27, which acts as a light receiving element. Further, an object lens 29, which focuses the laser beam to a recording layer of the optical disk 21, is provided in the optical pick-up 24.

The photo diode 27 converts intensity of the received reflected laser beam into voltage and sends a voltage signal a. The signal a is sent to an RF amplifier 34.

The RF amplifier 34, which acts as generating means, shapes waveforms of the signal a, which has been sent from the optical pick-up 24, and binarizes the signal a so as to generate a binarized RF signal b.

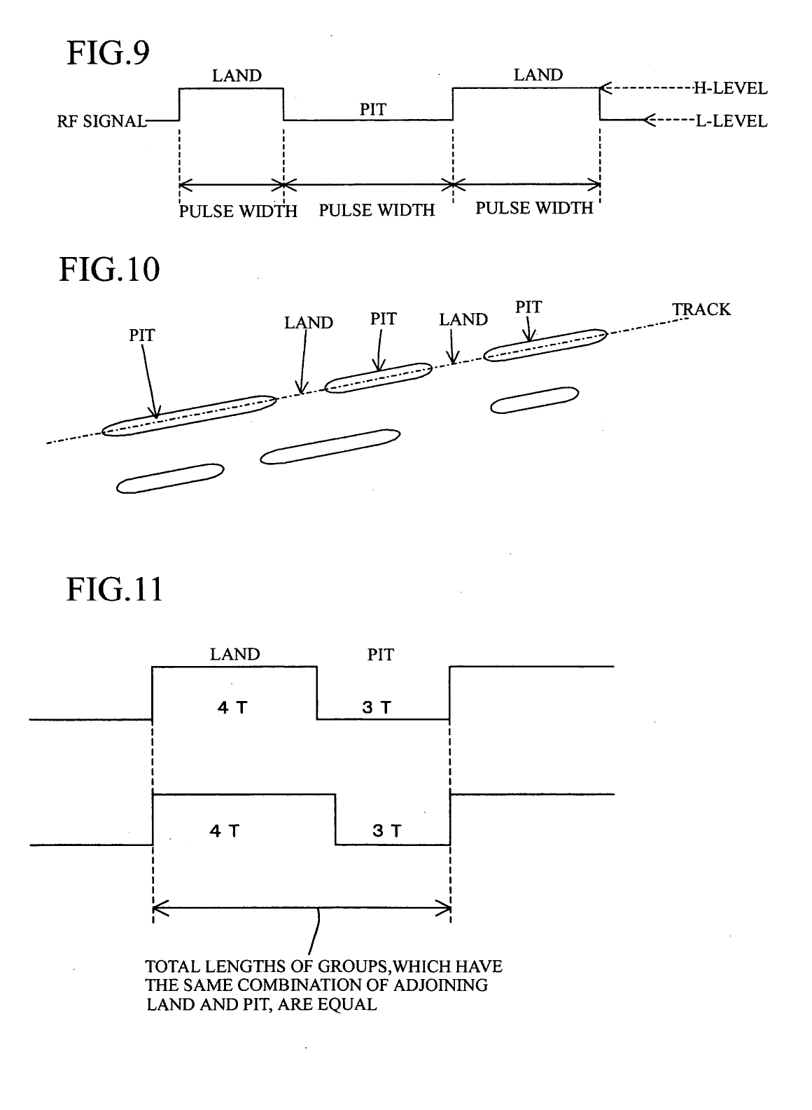

As shown in FIG. 9, high (H) level sections and low (L) level sections are alternately appear in the binarized RF signal b. The intensity of the reflected laser beam corresponding to the H-level sections are high, namely the H-level sections correspond to lands in the recording face of the optical disk 21. On the other hand, the intensity of the reflected laser beam corresponding to the L-level sections are low, namely the L-level sections correspond to pits in the recording face of the optical disk 21.

Note that, a focus error signal generating circuit (not shown) and a tracking error signal generating circuit (not shown) are provided in the RF amplifier 34, and they respectively generate a focus error signal c and a tracking error signal d on the basis of the signal a sent from the optical pick-up 24.

The focus error signal c and the tracking error signal d are sent to a servo processor 30. The servo processor 30 controls focus servo and tracking servo on the basis of the signals c and d and servo-controls the spindle motor 22 and a movement of the optical pick-up 24.

Note that, an interface 50 for connecting to an external apparatus is provided to the optical disk apparatus. Several types of the interface 50, e.g., ATAPI (AT Attachment Packet Interface), USB (Universal Serial Bus), IEEE1394, can be employed.

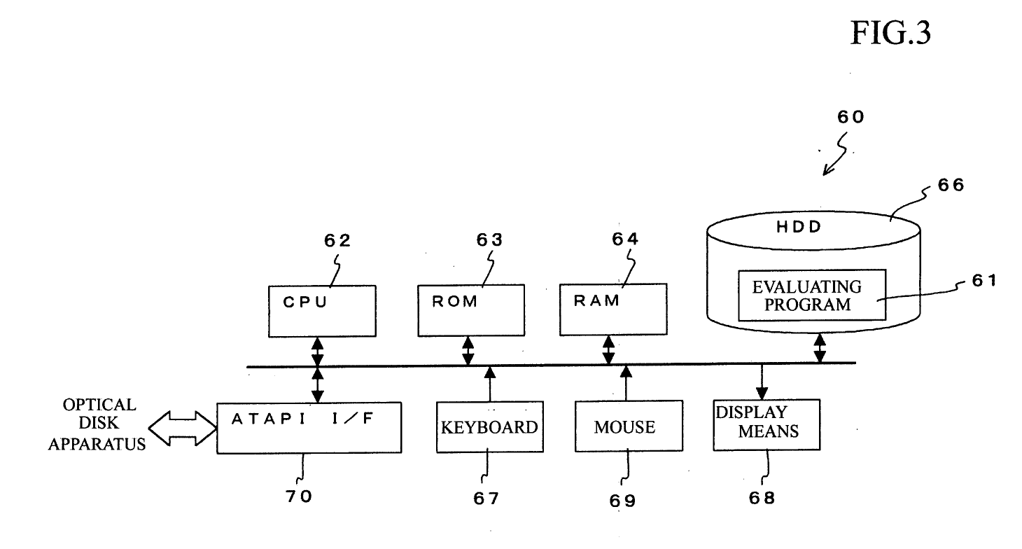

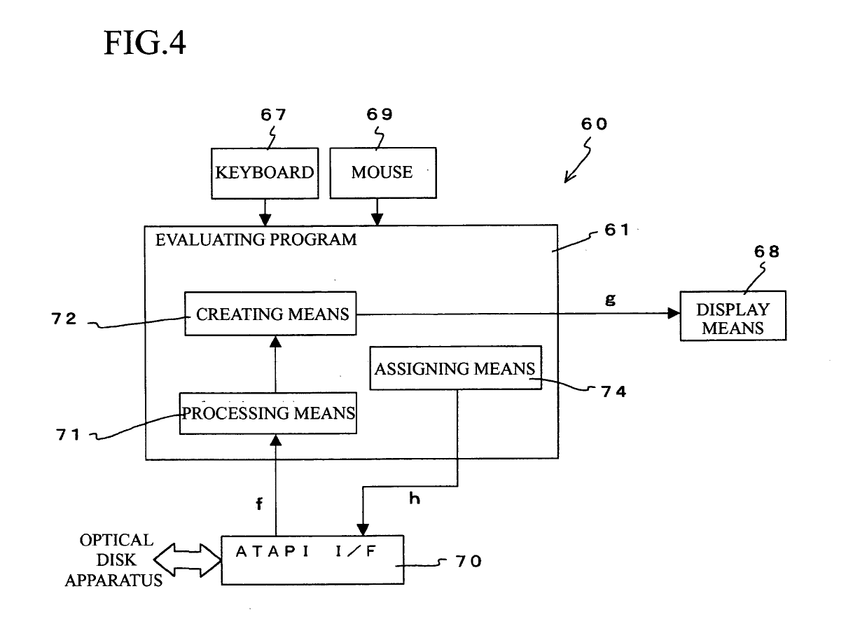

In the present embodiment, the optical disk apparatus employs the ATAPI type interface 50 so as to connect to a multipurpose computer 60 (see FIGS. 3 and 4).

Data f collected by collecting means 38 are converted into data, which can be treated by the computer 60, and outputted by the interface 50.

The interface 50 converts collected data f, which have been collected in the collecting means 38, so as to be used by the computer 60.

The binarized RF signal b, which has been generated by the RF amplifier 34, is sent to measuring means 36, which serially measures pulse widths of the signal b in chronological order. In the present embodiment, the measuring means 36 is one of functions of an IC, which acts as a decoder 40 for decoding the binarized RF signal b. However, the measuring means 36 is not limited to the present embodiment. For example, a circuit for or a software capable of measuring pulse widths may be employed as the measuring means 36.

Pulse widths e of the H-level sections and the L-level sections of the binarized RF signal b, which have been measured by the measuring means 36, are sent to the collecting means 38.

The collecting means 38 includes: a memory unit 44 for collecting the pulse widths e and number of pulses for each pulse width e; and a control unit 42 for controlling the memory unit 44 to store the data measured by the measuring means 36 in the memory unit 44.

In the present embodiment, the collecting means 38 is one of functions of the IC, which acts as the decoder 40 for decoding the binarized RF signal b, as well as the measuring means 36. However, the collecting means 38 is not limited to the present embodiment. For example, a circuit separated from the IC may be employed as the collecting means 38.

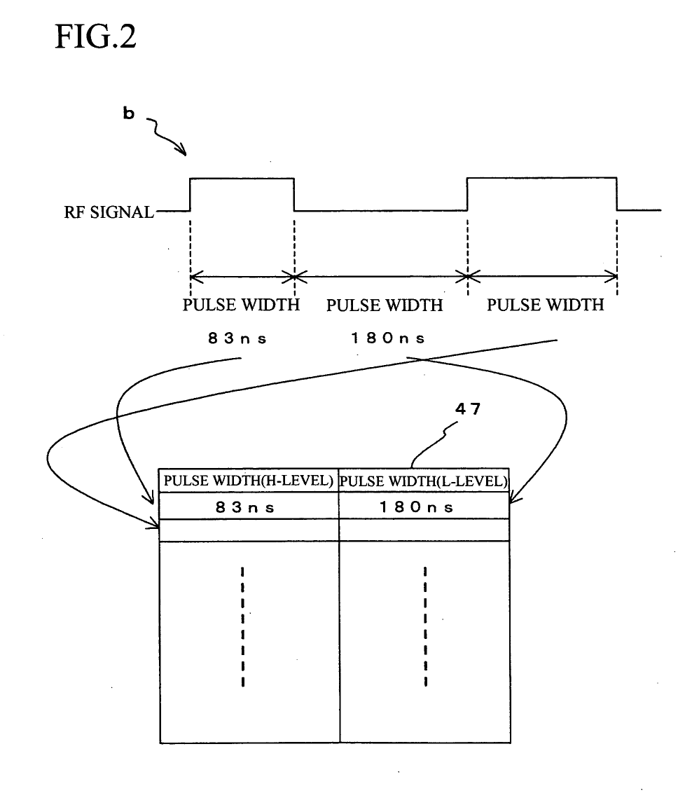

A data collecting method performed by the collecting means 38 will be explained with reference to FIG. 2.

The memory unit 44 of the collecting means 38 includes a table 47 for storing pulse width data of a plurality of groups, in which the pulse width data of each group are the pulse width of one H-level section and the pulse width of one L-level section immediately following said H-level section. For example, when a prescribed pulse width of the H-level section of the binarized RF signal b is 83 ns, if the measuring means 36 measures a L-level section of 180 ns immediately after measuring the H-level section of 83 ns, the control unit 42 of the collecting means 38 controls the memory unit 44 so as to collect the value of 83 ns of the H-level section and the value of 180 ns of the L-level section as pulse width data of one group. A plurality of groups of the pulse width data will be stored in the memory unit 44.

In the present embodiment, the pulse width data of each group are the pulse width of one H-level section and the pulse width of one L-level section immediately following said H-level section. The pulse width data may be a pulse width of one L-level section and the pulse width of one H-level section immediately following said L-level section.

Next, the structure of the computer 60 will be explained with reference to FIGS. 3 and 4.

The computer 60 is an ordinary multipurpose computer. The computer 60 comprises: a central processing unit (CPU) 62; a ROM 63 and a RAM 64 for storing programs and data; a hard disk drive unit (HDD) 66 for storing programs and data; display means 68, e.g., CRT, LCD, for displaying data; and a keyboard 67 and a mouse 69 for inputting data.

The computer 60 has an interface 70 for connecting to the optical disk apparatus 20 so as to communicate therewith.

Several types of the interface 70, e.g., ATAPI (AT Attachment Packet Interface), USB (Universal Serial Bus), IEEE1394, can be employed.

In the present embodiment, the computer 60 employs the ATAPI type interface 70 so as to connect to the optical disk apparatus 20.

The computer 60 further comprises: processing means 71 for processing the collected data f so as to analyze intersignal interference of recorded data; and creating means 72 for creating display data g, which are shown by the display means 68, on the basis of the data processed by the processing means 71.

In the present embodiment, when the processing means 71 receives the collected data f from the optical disk apparatus 20 via the interface 70, the processing means 71 processes the data f so as to display them as graphs for analyzing intersignal interference.

The creating means 72 creates display data g, which are data for displaying the graphs on the display means 68. The creating means 72 forwards the display data g to the display means 68, and the display means 68 displays the graphs on the basis of the display data g.

The processing means 71 and the creating means 72 are realized by controlling the CPU 62 on the basis of the prescribed program 61. The program 61 is a program for evaluating the optical disk apparatus. The evaluating program 61 may be previously installed in the HDD 66.

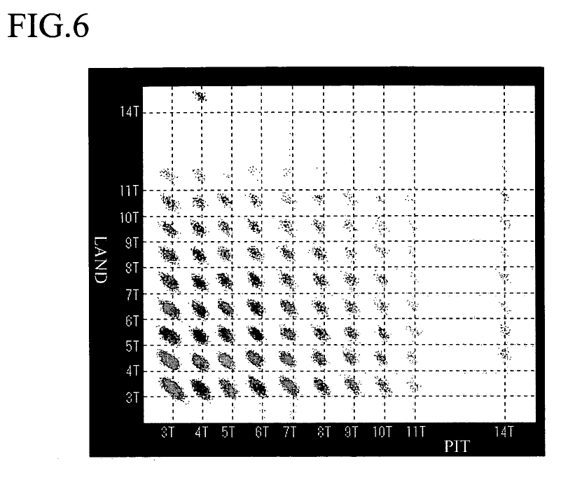

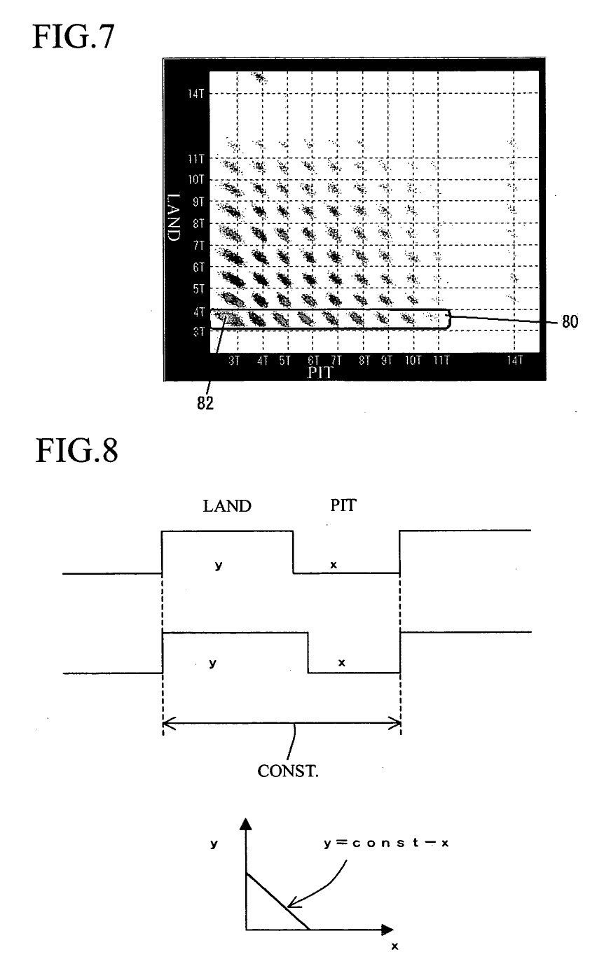

Examples of the graphs for analyzing the intersignal interference is shown in FIGS. 6 and 7.

In the graphs, horizontal axes are pulse widths of the L-level sections, each of which immediately follows the H-level section; vertical axes are pulse widths of the H-level sections, each of which appears immediately before the L-level section of the horizontal axis. Note that, as described above, the pulse widths of the H-level sections correspond to lengths of lands, and the pulse widths of the L-level sections correspond to lengths of pits adjoined the lands. Thus, the pulse widths of the adjoined H-level sections and the L-level sections, which correspond to the lengths of the adjoined lands and pits, can be shown as matrix graphs.

The evaluating program 61 is capable of assigning addresses of the optical disk 21 so as to measure the pulse widths of the H- and L-level sections of the binarized RF signal in the assigned addresses. At that time, the evaluating program 61 sends an address signal h to the optical disk apparatus 20.

Namely, when a user starts the evaluating program 61 with the keyboard 67 or the mouse 69, a message for assigning an address is displayed on the display means 68.

The user inputs an address of data to be evaluated to assigning means 74 of the computer 60 via the keyboard 67 or the mouse 69.

The assigning means 74 generates the address signal h on the basis of the address inputted by the user and sends the address signal h to the optical disk apparatus 20 via the interface 70.

The measuring means 36 of the optical disk apparatus 20 measures the pulse widths of the assigned address, which is assigned by the address signal h.

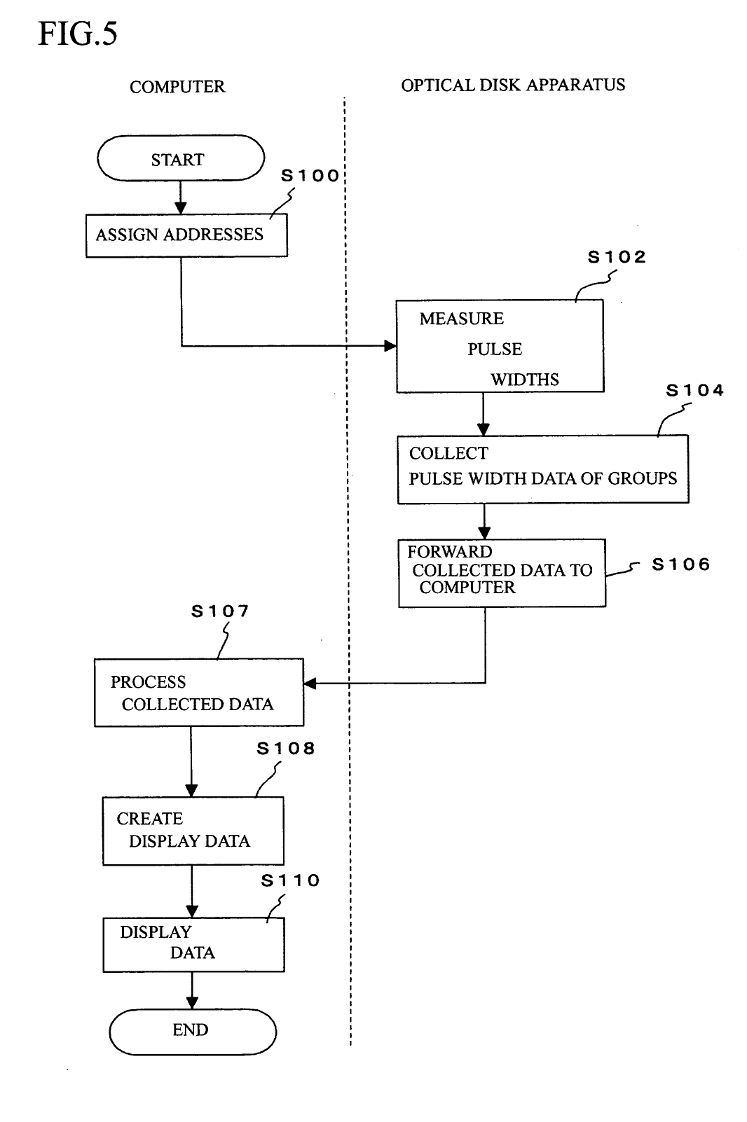

Successively, action of the system for evaluating the optical disk apparatus 20, which includes the computer 60, will be explained with reference to FIG. 5.

Firstly, the user starts the evaluating program 61 of the computer 60 (START).

When the evaluating program 61 is started, the user inputs addresses to be measured (step S100).

The address signal h of the assigned addresses is sent to the optical disk apparatus 20.

The measuring means 36 of the optical disk apparatus 20 measures the pulse widths of the H- and L-level sections of the binarized RF signal, which exists between the assigned addresses (step S102).

The collecting means 38 of the optical disk apparatus 20 collects number of the measured pulse widths for each pulse width of each level section (step S104). The concrete method of collecting the pulse width data has been described with reference to FIG. 2, so the method will be omitted here.

The control unit 42 of the collecting means 38 periodically forwards the collected pulse width data f to the computer 60 via the interface 50 (step S106).

In the computer 60, the processing means 71 processes the collected data f, which have been sent from the optical disk apparatus 20, so as to analyze intersignal interference of data recorded between the assigned addresses (step S107). For example, in the present embodiment, the collected data f are converted into data for showing lengths of lands and pits as matrix graphs.

Then, the creating means 72 processes the data, which are the lengths of the adjoining lands and pits, so as to create the display data g, which are data for displaying the matrix graphs on the display means 68 (step S108).

When the display data g are sent from the creating means 72 to the display means 68, the display means 68 displays the matrix graphs of groups of the adjoining lands and pits on the basis of the display data g (step S110).

Upon displaying the graphs, the action of the system terminates (END).

Examples of the matrix graphs displayed by the display means 68 will be explained with respect to FIGS. 6 and 7.

As described above, in the graphs, the horizontal axes indicate pulse width (unit: T) corresponding to pits, and the vertical axes indicate pulse width (unit: T) corresponding to lands, each of which is located immediately before the pit. Namely, the pulse widths of groups of the adjoining lands and pits are shown as the matrix graphs.

Each cross point of dotted lines indicates desired pulse widths of the adjoining land and pit. However, actually measured pulse widths of all adjoining lands and pits are deviated from the cross points. The measured pulse widths distribute like an ellipse with respect to each cross point. In the present embodiment, a left side of each elliptic distribution (set) is located on the upper side of the cross point; a right side thereof is located on the lower side of the cross point.

The reason of forming the elliptic set will be explained. As described in BACKGROUND OF THE INVENTION, if the adjoining land and pit have the same lengths or pulse widths, the total length thereof is fixed. For example, the lengths or the pulse widths of the adjoining land and pit are 3T, the total length of the length of the land (x) and the length of the pit (y) is indicated as x+y=const. (see FIG. 8). Therefore, y=−x+const., so that the graph is shown as a straight line with the slope of −1 in a graph, whose vertical axis indicates the length of land (x) and whose horizontal axis indicates the length of pit (y).

Quality of recorded data shown in FIG. 6 is relatively good. On the other hand, quality of recorded data shown in FIG. 7 is relatively bad.

In FIG. 7, Sets 80 of pits corresponding to the land of 3T upwardly deviate from the cross points and close to the land of 4T. Namely, it is difficult to distinguish the land of 3T from that of 4T.

Especially, a set 82 of 3T land-3T pit excessively expanded toward upper left, so that the set 82 interferes with a lower part of a set of 4T land-3T pit.

With the matrix graphs for analyzing the intersignal interference, quality of recorded data can be evaluated by measuring deviations of the elliptic sets from the cross points, observing deformation of the elliptic sets, etc.

The deviations of the elliptic set may be detected by the steps of: calculating barycenteric positions of the elliptic sets by the processing means 72; and displaying the calculated barycenteric positions on the display means 68. In another example, it may be detected by the steps of: calculating positions of the densest parts of the elliptic sets by the processing means 72; and displaying the calculated densest positions on the display means 68. With these methods, the user can clearly know the deviations of the elliptic sets with respect to the cross points.

By analyzing the intersignal interference, the user is capable of evaluating quality of the recorded data.

The data of the matrix graphs for analyzing the intersignal interference can be stored in the HDD 66 of the computer 60. When other data of the matrix graphs are created, the latter data can be compared with the former data by overlapping, so that qualities of the recorded data can be compared. Preferably, the creating means 72 transmits the matrix graphs of the latter data through that of the former data, so that the both graphs can be overlapped and compared.

Note that, the optical disk apparatus, the system and the program of the present invention are capable of evaluating quality of data written by not only the optical disk apparatus 20 but also other optical disk apparatuses.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A system for evaluating optical disk apparatus including an optical disk apparatus, which is capable of writing data in an optical disk, and a computer, which is connected to said optical disk apparatus and capable of communicating therewith,
wherein said optical disk apparatus comprises:
an optical pick-up irradiating an laser beam toward the optical disk and receiving a reflected laser beam reflected from the optical disk;
means for generating a binarized RF signal, which alternately includes high level sections corresponding to lands formed in a recording surface of the optical disk and low level sections corresponding to pits formed in the recording surface of the optical disk, from the reflected laser beam received by the optical pick-up;
means for measuring pulse widths of the high level sections and the low level sections in a plurality of parts of the binarized RF signal in chronological order;
means for collecting pulse width data of a plurality of groups measured by said measuring means, in which the pulse width data of each group are the pulse width of one high level section and the pulse width of one low level section adjoining said high level section; and
an interface capable of forwarding the collected pulse width data to said computer, and
wherein said computer comprises:
display means;
an interface capable of communicating with the optical disk apparatus;
means for processing the collected pulse width data, which are sent from said optical disk apparatus, so as to analyze intersymbol interference of the binarized RF signal; and
means for creating display data, which are shown by said display means, on the basis of the data processed by said processing means.

2. The system according to claim 1,
wherein said processing means processes the collected pulse width data so as to show a graph on said display means,
a horizontal axis of the graph is the pulse width of one of the high-level section and the low-level section, and a vertical axis of the graph is the pulse width of the other,
the graph indicates relationship between the pulse width of the high-level section and the pulse width of the low-level section of the groups, and
said creating means creates the display data for showing the graph.

3. A program for evaluating an optical disk apparatus, which is capable of writing data in an optical disk and connected to a computer,
wherein said program can be installed in said computer,
said optical disk apparatus comprises:
an optical pick-up irradiating an laser beam toward the optical disk and receiving a reflected laser beam reflected from the optical disk;
means for generating a binarized RF signal, which alternately includes high level sections corresponding to lands formed in a recording surface of the optical disk and low level sections corresponding to pits formed in the recording surface of the optical disk, from the reflected laser beam received by the optical pick-up;
means for measuring pulse widths of the high level sections and the low level sections in a plurality of parts of the binarized RF signal in chronological order;
means for collecting pulse width data of a plurality of groups measured by said measuring means, in which the pulse width data of each group are the pulse width of one high level section and the pulse width of one low level section adjoining said high level section; and
an interface capable of forwarding the collected pulse width data to said computer, and
wherein said program has functions of:
processing the collected pulse width data, which are sent from said optical disk apparatus, so as to analyze intersymbol interference of the binarized RF signal; and
creating display data, which are shown by display means of said computer, on the basis of the processed data.

4. The program according to claim 3,
wherein the collected pulse width data are processed so as to show a graph on said display means,
a horizontal axis of the graph is the pulse width of one of the high-level section and the low-level section, and a vertical axis of the graph is the pulse width of the other,
the graph indicates relationship between the pulse width of the high-level section and the pulse width of the low-level section of the groups, and
the display data are created to show the graph.
